(19) United States
(12) Patent Application Publication
(10) Pub. No.: US 2019/0291505 A1
(43) Pub. Date: Sep. 26, 2019

(54) SCULPTURE IN THREE-DIMENSIONAL TRANSPARENT SPACE AND METHOD FOR MANUFACTURING SAME

(71) Applicants: Sung Bae LEE, Daejeon (KR); Kyu Tae KIM, Daejeon (KR)

(72) Inventors: Sung Bae LEE, Daejeon (KR); Kyu Tae KIM, Daejeon (KR)

(21) Appl. No.: 16/463,080

(22) PCT Filed: Nov. 22, 2016
(86) PCT No.: PCT/KR2016/013469

§ 371 Date: May 22, 2019

(51) Int. Cl. B44F 7/00; B44C 5/00

(52) U.S. Cl. CPC B44F 7/00; B44C 5/00

(57) ABSTRACT

The present invention relates to a technology which enables a desired shape to be freely represented using sculpture components in a three-dimensional space filled with a transparent material. The present invention is characterized in that, when a sculpture is manufactured by installing, in a three-dimensional space, a text, a picture, a model, and a real object consisting of at least one of points, lines, surfaces, and solids, the shape of the sculpture can be freely represented using a transparent carrier containing at least one of the text, the picture, the model, and the real object, and a transparent carrier serving as a fixing means.

### TECHNICAL FIELD

The present disclosure relates to a sculpture manufactured in a three-dimensional transparent space filled with a transparent material, and more particularly, to a sculpture in three-dimensional transparent space, in which the sculpture is able to be freely represented in a desired shape in a three-dimensional transparent space by accommodating a text, a picture, an inner model, and a real object as components, and a transparent binder as a fixing means or a transparent carrier as a moving means, and a method of manufacturing the same.

### BACKGROUND ART

A three-dimensional sculpture is composed of elements, such as texts, pictures, models, and real objects, which may be represented by one or more of points, lines, surfaces, and solids. The representation range of the three-dimensional sculpture is wide in order of texts, pictures, models, and real objects, but the reality thereof is large in order of real objects, models, pictures, and texts.

FIG. 10 is a diagram illustrating one that is able to be represented (0) and one that is not able to be represented (X) using a point, a line, a surface, and a solid in two dimensions (two-dimensional plane). As illustrated in FIG. 10, each of the point, the line, and the surface may represent a text and a picture, but may not represent a model and a real object. The solid may not represent a text, a picture, a model, and a real object.

FIG. 11 is a diagram illustrating one that is able to be represented and one that is not able to be represented using a point, a line, a surface, and a solid in three dimensions (three-dimensional space). As illustrated in FIG. 11, the solid may represent all of a text, a picture, a model, and a real object. The surface, the line, and the point may represent only a text and a picture and may not represent a model and a real object.

Thus, conventionally, some of the text, the picture, the model, and the real object may not be represented by the point, the line, and the surface. Therefore, there is a need for a technology capable of freely representing all of them in a desired shape.

### DISCLOSURE

### Technical Problem

A first object of the present invention is directed to manufacturing a sculpture freely represented in a desired shape using at least one of a text, a picture, a model, and a real object, which are composed of at least one of a point, a line, a surface, and a solid, and a transparent binder in a transparent space.

A second object of the present invention is directed to manufacturing a sculpture freely represented in a desired shape using at least one of a text, a picture, a model, and a real object, which are composed of at least one of a point, a line, a surface, and a solid, and a transparent carrier in a three-dimensional transparent region.

A third object of the present invention is directed to manufacturing a sculpture freely represented in a desired shape using at least one of a text, a picture, a model, and a real object, which are composed of at least one of a point, a line, a surface, and a solid, a transparent binder, and a transparent carrier in a transparent space.

### Technical Solution

In order to accomplish the above objects, in accordance with a first aspect of the present invention, there is provided a sculpture in three-dimensional transparent space, which includes a sculpture component including at least one of a text, a picture, an inner model, and a real object and installed in a three-dimensional space, a transparent binder fixing the sculpture component at a desired position in an accommodation frame defining the three-dimensional space in which the sculpture is positioned, and a transparent material filled in an empty space in the three-dimensional space.

In accordance with a second aspect of the present invention, there is provided a sculpture in three-dimensional transparent space, which includes a sculpture component including at least one of a text, a picture, a model, and a real object and installed in a three-dimensional space, a transparent carrier including at least one of the text, the picture, the model, and the real object, made of a transparent material, and installed in an accommodation frame defining the three-dimensional space in which the sculpture is positioned, and a transparent material filled in an empty space in the three-dimensional space.

In accordance with a third aspect of the present invention, there is provided a sculpture in three-dimensional transparent space, which includes a sculpture component including at least one of a text, a picture, a model, and a real object and installed in a three-dimensional space, a transparent carrier including at least one of the sculpture components, made of a transparent material, and installed in the three-dimensional space, a transparent binder fixing the sculpture component and the transparent carrier at desired positions in an accommodation frame defining the three-dimensional space in which the sculpture is positioned, and a transparent material filled in an empty space in the three-dimensional space.

In order to accomplish the above objects, in accordance with a first aspect of the present invention, there is provided a method of manufacturing a sculpture in three-dimensional transparent space, which includes (a) installing an accommodation frame to define a three-dimensional space in which a sculpture is positioned, (b) placing a sculpture component including at least one of a text, a picture, a model, and a real object in the three-dimensional space, (c) fixing the sculpture component at a desired position in the accommodation frame using a transparent binder made of a transparent material, and (d) filling an empty space in the three-dimensional space with a transparent material and then removing the accommodation frame.

In accordance with a second aspect of the present invention, there is provided a method of manufacturing a sculpture in three-dimensional transparent space, which includes (a) installing an accommodation frame to define a three-dimensional space in which a sculpture is positioned, (b) placing a sculpture component including at least one of a text, a picture, a model, and a real object in the three-dimensional space, (c) placing a transparent carrier at a desired position in the three-dimensional space, the transparent carrier including at least one of a text, a picture, a model, and a real object and made of a transparent material, and (d) filling an empty space in the three-dimensional space with a transparent material and then removing the accommodation frame.

In accordance with a third aspect of the present invention, there is provided a method of manufacturing a sculpture in three-dimensional transparent space, which includes (a) installing an accommodation frame to define a three-dimensional space in which a sculpture is positioned, (b) placing a sculpture component including at least one of a text, a picture, a model, and a real object in the three-dimensional space, (c) placing a transparent carrier at a desired position in the three-dimensional space, the transparent carrier including at least one of a text, a picture, a model, and a real object and made of a transparent material, (d) installing the sculpture component and the transparent carrier at desired positions in the three-dimensional space using a transparent binder made of a transparent material, and (e) filling an empty space in the three-dimensional space with a transparent material and then removing the accommodation frame.

### Advantageous Effects

The present invention is effective in that a transparent sculpture is freely and visually designed in a desired shape in a transparent space using at least one of a text, a picture, a model, and a real object, which are composed of at least one of a point, a line, a surface, and a solid, and a transparent binder or a transparent carrier or both of them, thereby making it possible to realistically, variously, and accurately manufacture the transparent sculpture.

In addition, it is possible to shorten the manufacture time of a three-dimensional transparent sculpture and conveniently manufacture it by filling an empty space with a transparent dummy made of a transparent material when a sculpture object, which includes at least one of a text, a picture, a model, and a real object composed of at least one of a point, a line, a surface, and a solid, is installed in a transparent space using a transparent binder or a transparent carrier, or both of them.

### BRIEF DESCRIPTION OF DRAWINGS

FIG. 1 is a schematic view before a three-dimensional transparent sculpture according to a third embodiment of the present invention is finished.

FIG. 2 is a schematic view of a hexahedral accommodation frame according to the present invention.

FIGS. 3(a) to 3(d) are exemplary views of a transparent carrier according to the present invention.

FIG. 4 is a schematic view of a transparent binder according to the present invention.

FIG. 5 is a schematic view when the three-dimensional transparent sculpture according to the third embodiment of the present invention is finished.

FIG. 6 is a view illustrating a beer can as an example of the three-dimensional transparent sculpture according to the present invention.

FIG. 7 is a flowchart illustrating a first embodiment of a method of manufacturing a three-dimensional transparent sculpture according to the present invention.

FIG. 8 is a flowchart illustrating a second embodiment of a method of manufacturing a three-dimensional transparent sculpture according to the present invention.

FIG. 9 is a flowchart illustrating a third embodiment of a method of manufacturing a three-dimensional transparent sculpture according to the present invention.

FIG. 10 is a diagram illustrating one that is able to be represented and one that is not able to be represented using a point, a line, a surface, and a solid in two dimensions (two-dimensional plane).

FIG. 11 is a diagram illustrating one that is able to be represented and one that is not able to be represented using a point, a line, a surface, and a solid in three dimensions (three-dimensional space).

FIG. 12 is a diagram illustrating that a text, a picture, a model, and a real object are all represented using a point, a line, a surface, and a solid in a sculpture in a transparent space according to the present invention.

### MODE FOR DISCLOSURE

—Reference will now be made in detail to preferred embodiments of the present invention, examples of which are illustrated in the accompanying drawings.

Prior to description of a three-dimensional transparent sculpture and a method of manufacturing the same according to the present invention, the constituent sculpture components of the sculpture will be first described.

FIG. 12 is a diagram illustrating that a text, a picture, a model, and a real object are all represented using a point, a line, a surface, and a solid in a sculpture in a transparent space according to the present invention.

In the present invention, it is possible to freely represent a sculpture in a desired shape by accommodating a text, a picture, an inner model, and a real object, which are components of the sculpture, and a transparent binder as a fixing means or a transparent carrier as a moving means.

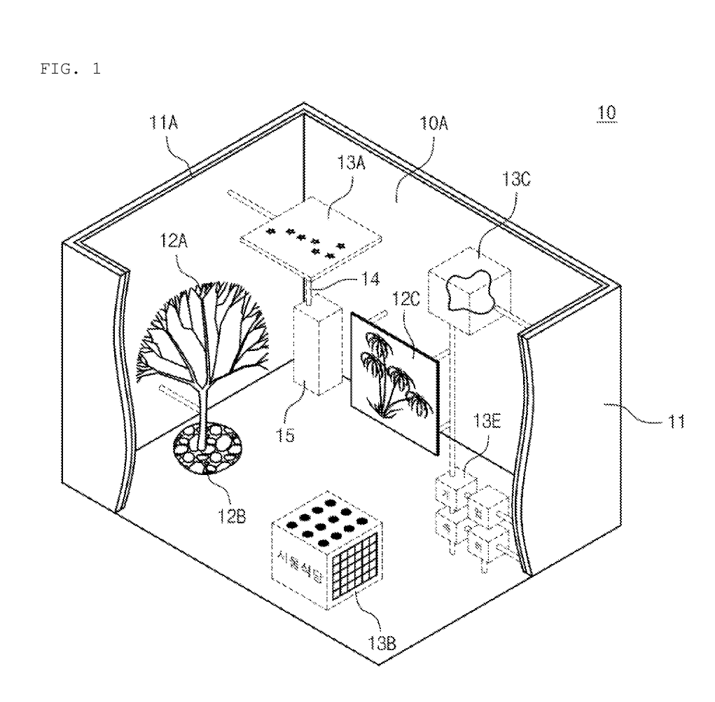

FIG. 1 is a schematic view illustrating a three-dimensional transparent sculpture according to a third embodiment of the present invention. As illustrated in FIG. 1, the sculpture, which is designated by reference numeral 10, includes: an accommodation frame 11 used to define a three-dimensional space 10A in which the sculpture 10 is installed; an inner model 12A, a real object 12B, a picture 12C, and a text 13E, which are sculpture components installed in the three-dimensional space 10A; transparent carriers 13A, 13B, 13C, and 13E made of a transparent material including at least one of a text, a picture, a model, and a real object; a transparent binder 14 for fixing the model 12A, the real object 12B, the picture 12C, and the text 13E, and the transparent carrier 13 to the accommodation frame; and a transparent dummy 15 made of a transparent material occupying a certain space in the three-dimensional space 10A. In the following description, the transparent carrier 13 means at least one of the transparent carriers 13A, 13B, 13C and 13E. Here, the picture 12C refers to an example in which an actual picture is directly drawn on a transparent carrier. The inner model 12A refers to a sculpture-shaped component installed in the three-dimensional space 10A.

A first embodiment of the present invention has a configuration in which the transparent carrier is removed from the components of the sculpture according to the third embodiment, and a second embodiment has a configuration in which the transparent binder is removed from the components of the sculpture according to the third embodiment. The first to third embodiments of the present invention will be described with reference to FIG. 1.

The accommodation frame 11 is removed after it is used to define the three-dimensional space 10A in which the sculpture 10 is placed. The shape of the accommodation frame 11 is not particularly limited, but the accommodation frame 11 may be manufactured in a shape corresponding to the shape of the three-dimensional transparent sculpture 10. For example, the accommodation frame 11 may be manufactured in various shapes such as a hexahedron or a cylinder.

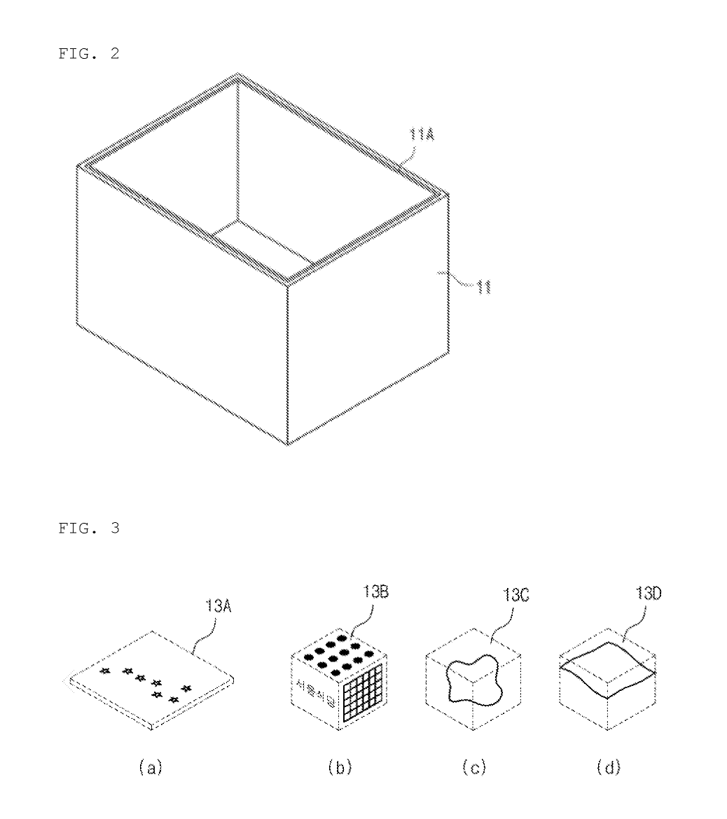

FIG. 2 exemplarily illustrates the hexahedral accommodation frame 11. As illustrated in FIG. 2, the accommodation frame 11 has a structure in which the upper portion thereof is open, the side and the lower portion thereof are integrally sealed, and it is hollow from the top to the bottom.

A finishing material 11A is installed on the inner surface of the accommodation frame 11 and is used to omit a separate finishing process such as surface treatment after the manufacturing process of the three-dimensional transparent sculpture 10 is completed. In particular, when a text or a picture is placed on the surface of the three-dimensional transparent sculpture 10, it is possible to produce a desired surface without performing a separate surface treatment process. The finishing material 11A may include an acrylic material.

The three-dimensional space 10A defined inside the accommodation frame 11 may be created in various forms. For example, the outside of the three-dimensional space 10A may be made of a transparent solid, and the inside thereof may lead to any one of a transparent solid, a transparent liquid including a gel, and a transparent gas. Here, the term “transparent” means that it not only is full transparent but also bright to the degree to which a text, a picture, a model, and a real object are distinguished from each other.

The sculpture 10 may include at least one of the inner model 12A, the real object 12B, the picture 12C, and the text 13E as components. The inner model 12A is manufactured by a person or a machine, and the type thereof is not particularly limited. In FIG. 1, the inner model 12A is exemplarily illustrated as a tree shape. The real object 12B means various kinds of real objects existing in nature, and the type thereof is not particularly limited. That is, the real object 12B is exemplarily illustrated as soil or gravel in FIG. 1, but the present invention is not limited thereto and may include all real objects. The picture 12C is exemplarily illustrated as being drawn on a transparent carrier. The text 13E may be directly written by a person, printed through a PC or the like, formed in an engraved or embossed shape, formed in a three-dimensional shape, or manufactured in other processes, and then installed in the three-dimensional space 10A. FIG. 1 illustrates an example in which individual texts are included in a transparent carrier.

The transparent carriers 13A, 13B, 13C, and 13E may include at least one of a text, a picture, a model, and a real object composed of at least one of a point, a line, a surface, and a solid in any one of solid-, liquid-, and gas-phase transparent spaces. Here, the real object may include at least one of a gas, a solid, and a liquid. FIG. 3 exemplarily illustrates transparent carriers according to the present invention. In FIG. 3, (a) illustrates a panel-shaped transparent carrier 13A in which a picture of the Big Dipper is included in a solid-phase transparent panel region, (b) illustrates a three-dimensional carrier 13B in which a text, a circular pattern, and a lattice are included in a solid-phase transparent space, (C) illustrates a three-dimensional carrier 13C in which a gas-phase cloud is included in a solid-phase transparent space, and (d) illustrates a three-dimensional carrier 13D in which a liquid (water) is included in a solid-phase transparent space. The material of the carriers 13A to 13D is not particularly limited, and may include an acrylic material. FIG. 1 illustrates an example in which the panel-shaped transparent carrier 13A, the three-dimensional carriers 13B and 13C, and the three-dimensional carrier 13E including individual characters (opening celebration) are provided as the transparent carrier 13. As a result, the transparent carrier 13 is made of a transparent material and serves to more conveniently install various-shaped sculpture components external to the sculpture 10 when the sculpture components are moved to and installed at desired positions in the three-dimensional space 10A.

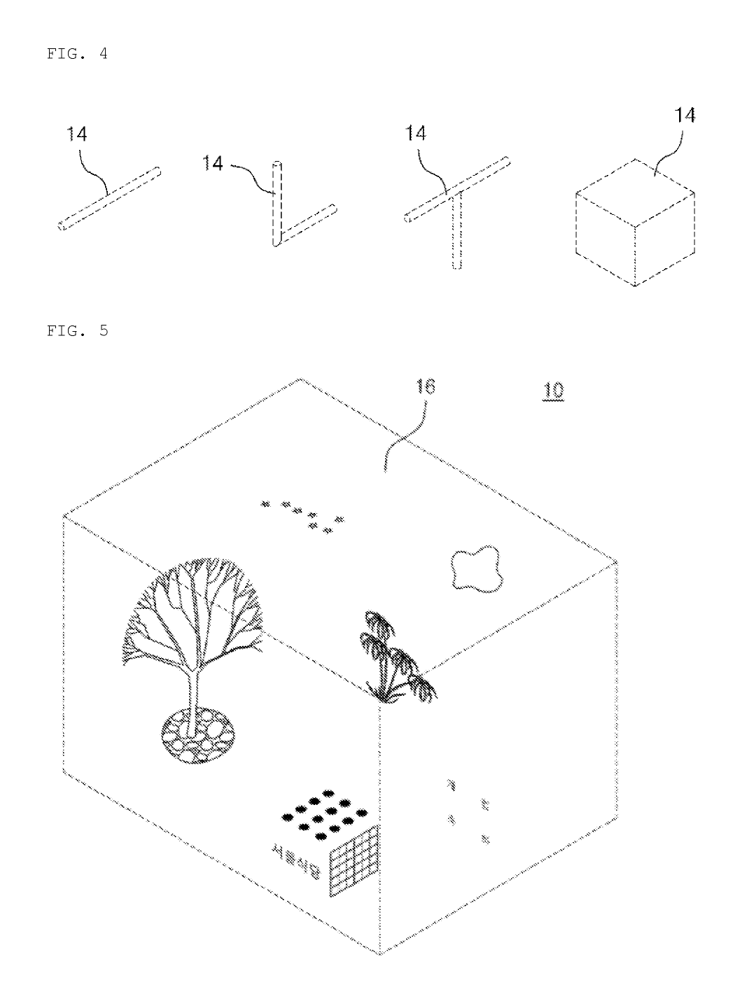

The transparent binder 14 is made of a transparent material and serves to fix sculpture components, such as the model 12 and the transparent carrier 13, to the bottom or side wall of the accommodation frame 11 or other sculpture components in order to install the sculpture components at desired positions (coordinates) in the transparent material 16. The material of the transparent binder 14 is not particularly limited, and may include an acrylic material. The shape of the transparent binder 14 is not particularly limited, and the transparent binder 14 may be manufactured in various shapes suitable to fix the sculpture components. FIG. 4 exemplarily illustrates the shape of the transparent binder 14. As illustrated in FIG. 4, the transparent binder 14 may be manufactured in a rod shape, an L shape, a T shape, a block shape, or the like.

The transparent dummy 15 is made of a transparent material and is filled in an empty space existing between the sculpture components installed in the three-dimensional space 10A.

Accordingly, when the finishing process is performed such that the sculpture components are installed (designed) in the three-dimensional space 10A and a remaining empty space is then filled with the transparent material 16, the transparent material 16 is less filled by the space of the transparent dummy 15, with the consequence that the time for the finishing process is shortened accordingly.

After the finishing process is performed, the accommodation frame 11 is removed from the three-dimensional space 10A. In this state, since the transparent carrier 13, the transparent binder 14, the transparent dummy 15, and the transparent material 16 installed in the three-dimensional space 10A are commonly made of a transparent material (e.g., an acrylic resin), the boundary between them is not seen and it is seen as the same one transparent space as in FIG. 5.

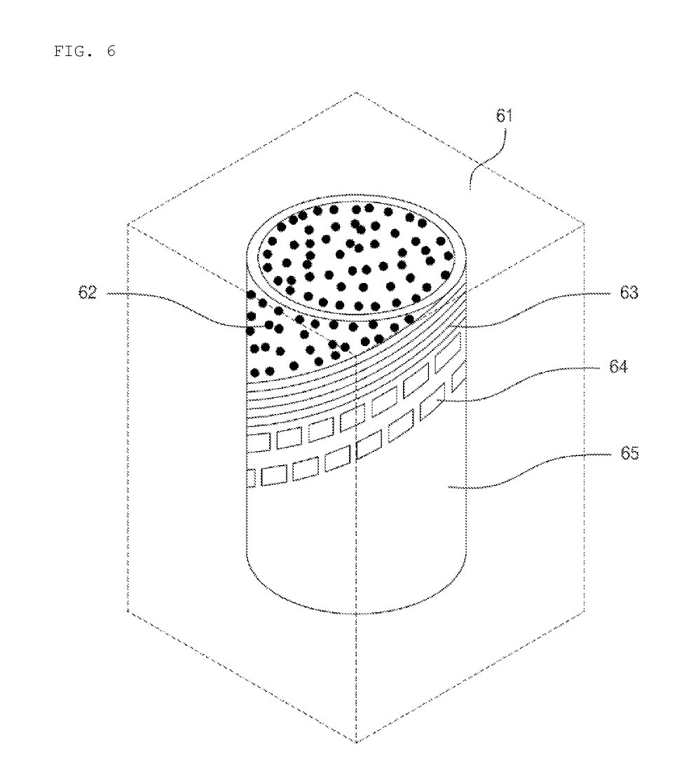

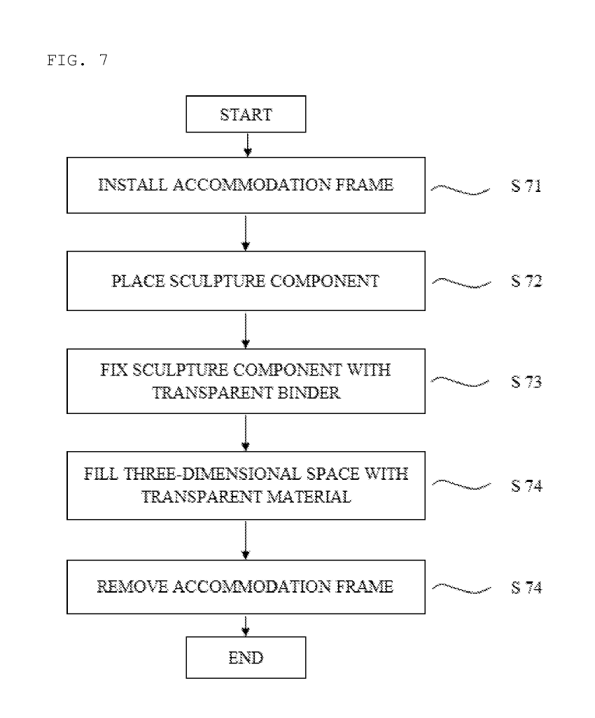

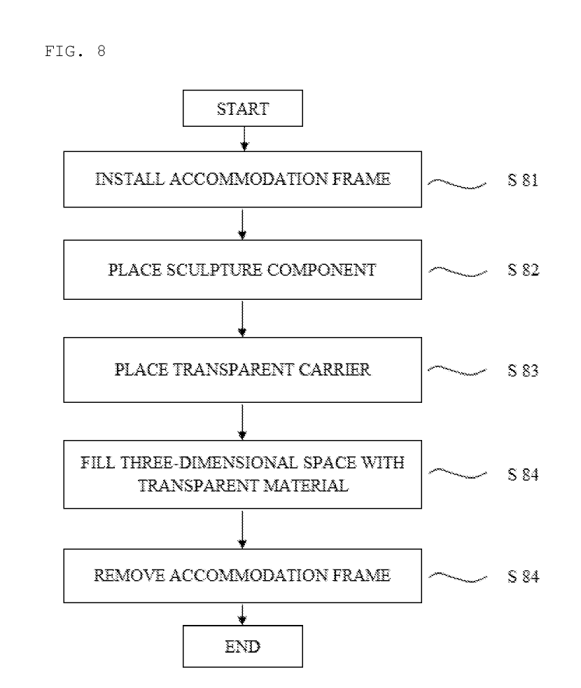

FIG. 6 illustrates an example in which a beer can is visually designed and manufactured using a transparent carrier. As illustrated in FIG. 6, it may include a transparent material 61, a point 62, a line 63, a surface 64, and a real object 65.

The transparent material 61 is a material filled in a space other than the sculpture component and may include an acrylic material. The point 62 is made by cutting the real object and its material may be various kinds of cloth, vinyl, plastic, wood, or the like. Here, an example is illustrated in which the point 62 is attached to the outside of the can-shaped transparent material. The line 63 is made by cutting the real object and its material may be cloth, vinyl, plastic, wood, or the like. Here, an example is illustrated in which the line 63 is attached to the outside of the can-shaped transparent material.

The surface 64 is made by cutting the real object and its material may be cloth, vinyl, plastic, wood, or the like. Here, an example is illustrated in which the surface 64 is attached to the outside of the can-shaped transparent material. The real object 65 is a beer can and its material may be aluminum. Here, an example is illustrated in which the real object 65 is attached to the outside of the can-shaped transparent material.

As a result, it can be seen in FIG. 6 that the point 62, the line 63, the surface 64, and the real object 65 are combined with a carrier as the transparent material so that the shape of the beer can is more conveniently, realistically, and variously represented. The sculpture may be used for advertisement or accessories.

FIG. 7 is a flowchart illustrating a first embodiment of a method of manufacturing a three-dimensional transparent sculpture according to the present invention. As illustrated in FIG. 7, the method includes a step of installing an accommodation frame (S71), a step of placing a sculpture component (S72), a step of fixing the sculpture component with a transparent binder (S73), a step of filling a three-dimensional space with a transparent material (S74), and a step of removing the accommodation frame (S75).

In the step of installing an accommodation frame (S71), an accommodation frame is installed in a desired shape to define a three-dimensional space in which a three-dimensional transparent sculpture is positioned.

In the step of placing a sculpture component (S72), a sculpture component is placed in the three-dimensional transparent space. The sculpture component may include at least one of a model, a real object, a picture, and a text composed of at least one of a point, a line, a surface, and a solid.

In the step of fixing the sculpture component with a transparent binder (S73), the sculpture component is installed at a desired position (coordinate) in the three-dimensional space using a transparent binder made of a transparent material. In this case, the sculpture component may be fixed to the bottom or side wall of the accommodation frame or another sculpture component by the transparent binder. The material of the transparent binder is not particularly limited, and may include an acrylic material.

In the step of filling a three-dimensional space with a transparent material (S74), a finishing process is performed in which an empty space between the sculpture component and another sculpture component in the three-dimensional space is filled with a transparent material. In this case, the empty space between the sculpture components may be filled with a transparent dummy made of a transparent material and then with the transparent material, thereby shortening the time for the finishing process accordingly.

In the step of removing the accommodation frame (S75), the accommodation frame is removed from the three-dimensional space.

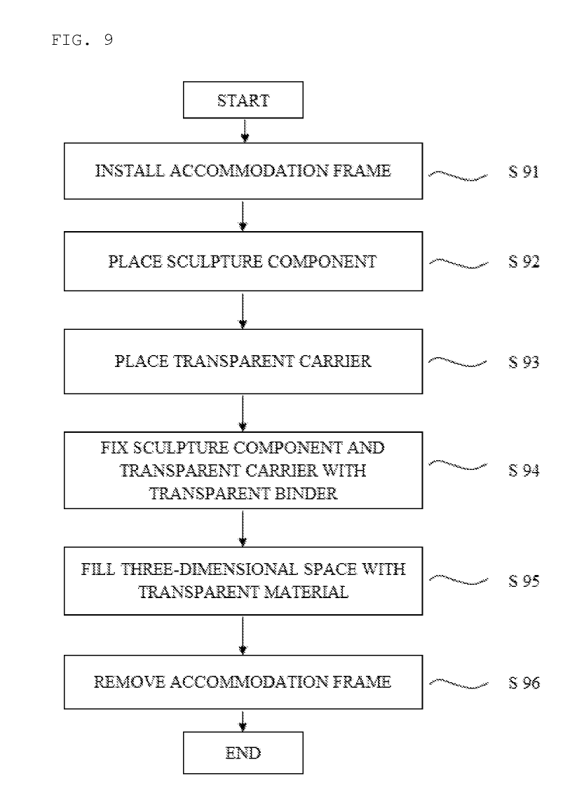

FIG. 8 is a flowchart illustrating a second embodiment of a method of manufacturing a three-dimensional transparent sculpture according to the present invention. As illustrated in FIG. 8, the method includes a step of installing an accommodation frame (S81), a step of placing a sculpture component (S82), a step of placing a transparent carrier (S83), a step of filling a three-dimensional space with a transparent material (S84), and a step of removing the accommodation frame (S85).

In the step of installing an accommodation frame (S81), an accommodation frame is installed in a desired shape to define a three-dimensional space in which a three-dimensional transparent sculpture is positioned.

In the step of placing a sculpture component (S82), a sculpture component is placed in the three-dimensional transparent space. The sculpture component may include at least one of a model, a real object, a picture, and a text composed of at least one of a point, a line, a surface, and a solid.

In the step of placing a transparent carrier (S83), a transparent carrier including at least one of a text, a picture, a model, and a real object is placed at a desired position (coordinate) in the three-dimensional space.

In the step of filling a three-dimensional space with a transparent material (S84), a finishing process is performed in which an empty space in the three-dimensional space is filled with a transparent material. In this case, the empty space in the three-dimensional space may be filled with a transparent dummy made of a transparent material and then with the transparent material, thereby shortening the time for the finishing process accordingly.

In the step of removing the accommodation frame (S85), the accommodation frame is removed from the three-dimensional space.

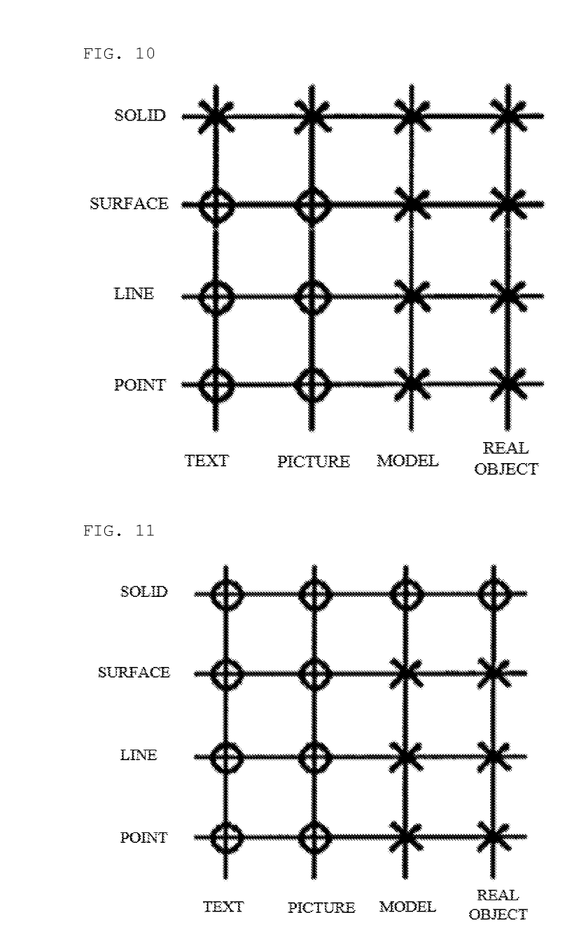

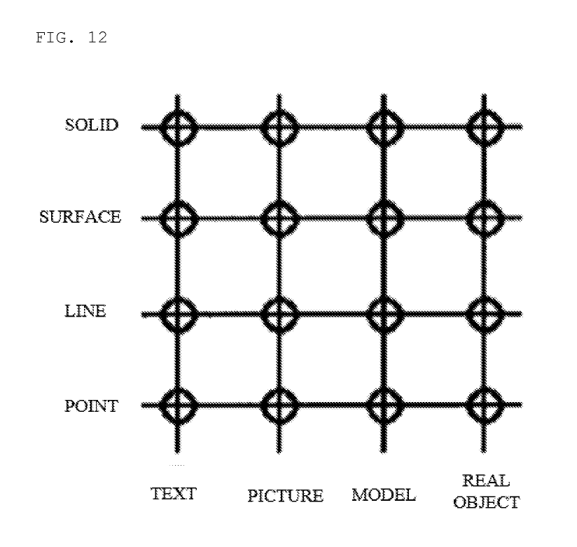

FIG. 9 is a flowchart illustrating a third embodiment of a method of manufacturing a three-dimensional transparent sculpture according to the present invention. As illustrated in FIG. 9, the method includes a step of installing an accommodation frame (S91), a step of placing a sculpture component (S92), a step of placing a transparent carrier (S93), a step of fixing the sculpture component and the transparent carrier with a transparent binder (S94), a step of filling a three-dimensional space with a transparent material (S95), and a step of removing the accommodation frame (S96).

In the step of installing an accommodation frame (S91), an accommodation frame is installed in a desired shape to define a three-dimensional space in which a three-dimensional transparent sculpture is positioned.

In the step of placing a sculpture component (S92), a sculpture component is placed in the three-dimensional space. The sculpture component may include at least one of a model, a real object, a picture, and a text composed of at least one of a point, a line, a surface, and a solid.

In the step of placing a transparent carrier (S93), a transparent carrier accommodating at least one of a text, a picture, a model, and a real object is placed at a desired position (coordinate) in the three-dimensional space. The transparent carrier is included in the sculpture component.

In the step of fixing the sculpture component and the transparent carrier with a transparent binder (S94), the sculpture component is placed at a desired position (coordinate) in the three-dimensional space using a transparent binder made of a transparent material. In this case, the sculpture component may be fixed to the bottom or side wall of the accommodation frame or another sculpture component by the transparent binder. The material of the transparent binder may include an acrylic material.

In the step of filling a three-dimensional space with a transparent material (S95), a finishing process is performed in which an empty space between the sculpture component and another sculpture component in the three-dimensional space is filled with a transparent material.

In this case, the empty space between the sculpture components may be filled with a transparent dummy made of a transparent material and then with the transparent material, thereby shortening the time for the finishing process accordingly.

In the step of removing the accommodation frame (S96), the accommodation frame is removed from the three-dimensional space.

While the present invention has been described with respect to the preferred embodiments illustrated in the drawings, it will be obvious to those skilled in the art that such embodiments are provided by way of example only. It will be understood by those skilled in the art that various modifications and other equivalent embodiments may be made without departing from the spirit and scope of the invention as defined in the following claims.

### DESCRIPTION OF THE REFERENCE NUMERALS

| | |
|---|---|
| 11: accommodation frame | 11A: finishing material |
| 12A: inner model | 12B: real object |
| 12C: picture | 13A-13E: transparent carrier |
| 14: transparent binder | 15: transparent dummy |

1. A sculpture in three-dimensional transparent space, comprising:
a sculpture component comprising at least one of a text, a picture, an inner model, and a real object and installed in a three-dimensional space;
a transparent binder fixing the sculpture component at a desired position in an accommodation frame defining the three-dimensional space in which the sculpture is positioned; and
a transparent material filled in an empty space in the three-dimensional space.

2. A sculpture in three-dimensional transparent space, comprising:
a sculpture component comprising at least one of a text, a picture, a model, and a real object and installed in a three-dimensional space;
a transparent carrier comprising at least one of the text, the picture, the model, and the real object, made of a transparent material, and installed in an accommodation frame defining the three-dimensional space in which the sculpture is positioned; and
a transparent material filled in an empty space in the three-dimensional space.

3. A sculpture in three-dimensional transparent space, comprising:
a sculpture component comprising at least one of a text, a picture, a model, and a real object and installed in a three-dimensional space;
a transparent carrier comprising at least one of the sculpture components, made of a transparent material, and installed in the three-dimensional space;
a transparent binder fixing the sculpture component and the transparent carrier at desired positions in an accommodation frame defining the three-dimensional space in which the sculpture is positioned; and
a transparent material filled in an empty space in the three-dimensional space.

4. The sculpture according to claim 2, wherein the transparent carrier comprises at least one of a gas and a liquid.

5. The sculpture according to claim 2, wherein the transparent carrier comprises any one of a line, a panel shape, and a three-dimensional shape.

6. The sculpture according to claim 2, wherein the transparent carrier comprises at least one of a text, a picture, a sculpture component, and a real object composed of at least one of a point, a line, a surface, and a solid.

7. The sculpture according to claim 1, wherein the transparent material is an acrylic material.

8. The sculpture according to claim 1, wherein the accommodation frame comprises a finishing material provided on its inner wall.

9. The sculpture according to claim 8, wherein the finishing material is an acrylic material.

10. The sculpture according to claim 1, wherein some of the three-dimensional space is filled with a transparent dummy made of a transparent material.

11. A method of manufacturing a sculpture in three-dimensional transparent space, comprising:
(a) installing an accommodation frame to define a three-dimensional space in which a sculpture is positioned;
(b) placing a sculpture component comprising at least one of a text, a picture, a model, and a real object in the three-dimensional space;
(c) fixing the sculpture component at a desired position in the accommodation frame using a transparent binder made of a transparent material; and
(d) filling an empty space in the three-dimensional space with a transparent material and then removing the accommodation frame.

12. A method of manufacturing a sculpture in three-dimensional transparent space, comprising:
(a) installing an accommodation frame to define a three-dimensional space in which a sculpture is positioned;
(b) placing a sculpture component comprising at least one of a text, a picture, a model, and a real object in the three-dimensional space;
(c) placing a transparent carrier at a desired position in the three-dimensional space, the transparent carrier comprising at least one of a text, a picture, a model, and a real object and made of a transparent material; and
(d) filling an empty space in the three-dimensional space with a transparent material and then removing the accommodation frame.

13. A method of manufacturing a sculpture in three-dimensional transparent space, comprising:
(a) installing an accommodation frame to define a three-dimensional space in which a sculpture is positioned;
(b) placing a sculpture component comprising at least one of a text, a picture, a model, and a real object in the three-dimensional space;
(c) placing a transparent carrier at a desired position in the three-dimensional space, the transparent carrier comprising at least one of a text, a picture, a model, and a real object and made of a transparent material;
(d) installing the sculpture component and the transparent carrier at desired positions in the three-dimensional space using a transparent binder made of a transparent material; and
(e) filling an empty space in the three-dimensional space with a transparent material and then removing the accommodation frame.

14. The method according to claim 11, wherein some of the three-dimensional space is filled with a transparent dummy made of a transparent material.

15. The method according to claim 11, wherein the accommodation frame comprises a finishing material provided on its inner wall.

16. A method of manufacturing a sculpture in three-dimensional transparent space, comprising:
(a) installing an accommodation frame to define a three-dimensional space in which a sculpture is positioned;
(b) placing a transparent carrier at a desired position in the three-dimensional space, the transparent carrier comprising at least one of a text, a picture, a model, and a real object and made of a transparent material; and
(c) filling an empty space in the three-dimensional space with a transparent material and then removing the accommodation frame.

17. A method of manufacturing a sculpture in three-dimensional transparent space, comprising:
(a) installing an accommodation frame to define a three-dimensional space in which a sculpture is positioned;
(b) placing a transparent carrier at a desired position in the three-dimensional space, the transparent carrier comprising at least one of a text, a picture, a model, and a real object and made of a transparent material;
(c) placing the sculpture component and the transparent carrier at desired positions in the three-dimensional space using a transparent binder made of a transparent material; and
(d) filling an empty space in the three-dimensional space with a transparent material and then removing the accommodation frame.

18. The sculpture according to claim 3, wherein the transparent carrier comprises at least one of a gas and a liquid.

19. The sculpture according to claim 3, wherein the transparent carrier comprises any one of a line, a panel shape, and a three-dimensional shape.

20. The sculpture according to claim 3, wherein the transparent carrier comprises at least one of a text, a picture, a sculpture component, and a real object composed of at least one of a point, a line, a surface, and a solid.

21. The sculpture according to claim 2, wherein the transparent material is an acrylic material.

22. The sculpture according to claim 2, wherein the accommodation frame comprises a finishing material provided on its inner wall.

23. The sculpture according to claim 2, wherein some of the three-dimensional space is filled with a transparent dummy made of a transparent material.

24. The sculpture according to claim 3, wherein the transparent material is an acrylic material.

25. The sculpture according to claim 3, wherein the accommodation frame comprises a finishing material provided on its inner wall.

26. The sculpture according to claim 3, wherein some of the three-dimensional space is filled with a transparent dummy made of a transparent material.

27. The method according to claim 12, wherein some of the three-dimensional space is filled with a transparent dummy made of a transparent material.

28. The method according to claim 12, wherein the accommodation frame comprises a finishing material provided on its inner wall.

29. The method according to claim 13, wherein some of the three-dimensional space is filled with a transparent dummy made of a transparent material.

30. The method according to claim 13, wherein the accommodation frame comprises a finishing material provided on its inner wall.
